(19) United States
(12) Patent Application Publication
(10) Pub. No.: US 2026/0274249 A1
(43) Pub. Date: Sep. 17, 2026

(54) DRIVING ASSISTANCE APPARATUS, DRIVING ASSISTANCE METHOD, AND NON-TRANSITORY STORAGE MEDIUM STORING PROGRAM THEREOF

(71) Applicants: TOYOTA JIDOSHA KABUSHIKI KAISHA, Aichi (JP); DENSO CORPORATION, Aichi-pref. (JP)

(72) Inventors: Kai OYA, Sagamihara-shi (JP); Fumio SUGAYA, Susono-shi (JP)

(21) Appl. No.: 19/557,114

(22) Filed: Mar. 5, 2026

(30) Foreign Application Priority Data
Mar. 14, 2025 (JP) 2025-040784

(51) Int. Cl. B60W 30/09; G01S 13/931; G06V 20/56

(52) U.S. Cl. CPC B60W 30/09; G01S 13/931; G06V 20/56; B60W 2554/4042; B60W 2556/35

(57) ABSTRACT

The driving assistance apparatus generates fusion object information by fusing radar object information including a radar ground speed of an object present ahead of a host vehicle and camera object information including a type and a camera ground speed of the object. The apparatus includes a controller configured to perform driving assistance control to reduce a collision risk between an object and the host vehicle based on the fusion object information. The controller performs the driving assistance control as necessary in a case where a specific situation is occurring with respect to a specific object whose fusion object information has been generated. The specific situation is a situation in which the radar ground speed of the specific object is within a first range including 0 and the camera ground speed of the specific object included in the camera object information is within a second range including 0.

### TECHNICAL FIELD

The present invention relates to a driving assistance apparatus configured to perform driving assistance control to reduce the risk of a collision between a host vehicle and an object moving at a relatively low speed, a driving assistance method therefor, and a non-transitory storage medium storing a program therefor.

### BACKGROUND

There is a known apparatus configured to generate fusion object information by fusing object information obtained using a radar and object information obtained using a camera and to perform driving assistance control to reduce the risk of a collision based on the generated fusion object information. One of the conventional apparatuses (hereinafter, referred to as a “conventional apparatus”) is configured to determine whether or not the object information obtained using the radar is erroneous (i.e., erroneous radar detection information) based on a behavior and a size of the object represented by the radar object information.

Furthermore, the conventional apparatus is configured to delete the fusion object information on the object that corresponds to the erroneous radar detection information and is detected by the radar only from the entire fusion object information so as to generate final fusion object information that is used for the driving assistance control (refer to Japanese Laid-open Patent Publication 2024-120231).

### SUMMARY

A guardrail contains a lot of metals. Therefore, a guardrail tends to reflect electric waves (e.g., radar waves in a millimeter wave band) used by a radar more easily than a motorcycle. Accordingly, for example, in such a scene shown in FIG. 4 and FIG. 5A, a case may occur in which the camera recognizes a motorcycle having a ground speed that is substantially equal to a ground speed of the host vehicle, and the radar detects the guardrail. In this case, as shown in FIG. 5B, they are erroneously fused (i.e., an erroneous fusion is carried out). As a result, the fusion object information indicates that a type of the object is a motorcycle recognized by the camera and the ground speed of the object is 0 km/h recognized by the radar. This causes the conventional driving assistance apparatus to determine that the collision risk with respect to the motorcycle is high and to erroneously perform the driving assistance control (e.g., deceleration control), as shown in FIG. 5C.

The present disclosure is directed to solving the problem described above. That is, an object of the present disclosure is to provide a driving assistance apparatus, a driving assistance method, and a program therefor that can reduce the possibility of performing unnecessary driving assistance control to reduce the risk of a collision with an object moving at a relatively low speed due to the erroneous fusion.

One of the embodiments of a driving assistance apparatus (hereinafter, referred to as a present disclosure apparatus) according to the present disclosure comprises:
a radar device (21) configured to obtain radar object information on an object present ahead of a host vehicle (HV) using radar waves, the radar object information including a radar ground speed representing a ground speed of the object;
a camera device (22) configured to obtain camera object information on an object present ahead of the host vehicle based on a captured image, the camera object information including a type of the object and a camera ground speed which represents a ground speed of the object;
a controller (10) configured to generate fusion object information by fusing the radar object information and the camera object information (S920) and to perform (permit) driving assistance control to reduce a collision risk between an object present ahead of the host vehicle and the host vehicle (S1120, S1140, S1155).

The controller is configured to perform (permit) the driving assistance control (S1110: Yes) in a case where a specific situation is occurring with respect to a specific object (n) whose fusion object information has been generated, the specific situation is a situation in which the radar ground speed (Vra(n)) of the specific object (n) serving as a fusion ground speed (Vf(n)) of the specific object (n) included in the generated fusion object information is within a first range including 0 (S925: Yes) and the camera ground speed (Vca(n)) of said specific object (n) is within a second range including 0 (S940: Yes).

According to the above-described apparatus, even when the fusion ground speed (i.e., the radar ground speed) of the specific object is within the first range due to the erroneous fusion, the driving assistance control is not performed if the camera ground speed of the specific object is not within the second range. Thus, the possibility that the driving assistance control is erroneously performed due to the erroneous fusion can be reduced.

In some embodiments,
the controller is configured to determine that the specific situation is occurring (that is, to permit the driving assistance control) when a total amount of time of a first state (a time corresponding to C(n)) becomes equal to or greater than a predetermined time threshold (a time corresponding to Cth) (S945 in FIG. 9 and S1110 in FIG. 11: Yes), wherein the first state is a state in which the fusion ground speed of the specific object is within the first range and the camera ground speed of the specific object is within the second range while the camera ground speed of the specific object continues to be within a third range that includes the second range (S935 in FIG. 9: Yes).

Since the accuracy of the camera ground speed (Vca(n)) is relatively low, there may be a case where the camera ground speed (Vca(n)) of an object n whose ground speed is actually within the second range becomes outside of the second range. However, even in such a case, it is unlikely that the camera ground speed (Vca(n)) becomes outside of the third range that includes the second range. Therefore, according to the above-described embodiment, the possibility that the driving assistance control is not performed for an object which should be subjected to the driving assistance control due to the insufficient accuracy of the camera ground speed Vca(n) can be reduced.

In some embodiments,
the controller is configured to determine that the specific situation is occurring (that is, to permit the driving assistance control) when a continuing time (a time corresponding to C(n)) which is a duration for which a second state continues becomes equal to or greater than a predetermined time threshold (a time corresponding to Cth) (S1110: Yes), wherein the second state is a state in which the fusion ground speed (Vf(n)) of the specific object is within the first range (S925 in FIG. 12: Yes) and the camera ground speed (Vca(n)) of the specific object is within the second range (S1210 in FIG. 12: Yes).

According to the above-described embodiment as well, the possibility that the driving assistance control is erroneously performed due to the erroneous fusion can be reduced.

In some embodiments,
the controller is configured to determine that the specific situation is occurring (that is, to permit the driving assistance control) when the fusion ground speed (Vf(n)) of the specific object is within the first range (S1410 in FIG. 14: Yes) at a time point at which a cumulative time (a time corresponding to C(n)) of a third state becomes equal to or greater than a predetermined time threshold (a time corresponding to Cth) (S945 in FIG. 13, S1110 in FIG. 14: Yes), wherein the third state is a state in which the camera ground speed (Vca(n)) of the specific object is within the second range in a case where the camera ground speed (Vca(n)) of the specific object remains within a third range that includes the second range (S935 in FIG. 13: Yes).

According to the above-described embodiment, the possibility that the driving assistance control is not performed for an object which should be subjected to the driving assistance control due to the insufficient accuracy of the camera ground speed Vca(n) can be reduced.

In some embodiments, the controller is configured to determine that the specific situation is occurring (that is, to permit the driving assistance control) when the fusion ground speed (Vf(n)) of the specific object is within the first range (S1410 in FIG. 14: Yes), in a case where a continuing time (a time corresponding to C(n)) which is a duration for which a fourth state continues becomes equal to or greater than a predetermined time threshold (a time corresponding to Cth) (S1510 in FIG. 15, S945 in FIG. 15, S1110 in FIG. 14: Yes), wherein the fourth state is a state in which the camera ground speed (Vca(n)) of the specific object is within the second range.

According to the above-described embodiment as well, the possibility that the driving assistance control is erroneously performed due to the erroneous fusion can be reduced.

Notably, in the above description, in order to facilitate understanding of the present disclosure, the constituent elements corresponding to those of embodiments which will be described later are accompanied by parenthesized symbols and/or names which are used in the embodiments; however, the constituent elements of the disclosure are not limited to those in the embodiments defined by the symbols and/or names. The present disclosure covers a driving assistance method, and a non-transitory storage medium storing a program thereof.

### BRIEF DESCRIPTION OF THE DRAWINGS

FIG. 1 is a schematic diagram of a driving assistance apparatus according to an embodiment of the present disclosure.

FIG. 2A shows a captured image and camera object information at a time point T.

FIG. 2B shows a captured image and camera object information at a time point T2.

FIG. 3A shows camera object information and radar object information.

FIG. 3B shows fusion object information.

FIG. 4 shows another captured image.

FIG. 5A shows a plan view of an object and a host vehicle.

FIG. 5B shows another plan view of an object and a host vehicle.

FIG. 5C shows yet another plan view of an object and a host vehicle.

FIG. 6A shows a plan view of an object and a host vehicle for describing steering control serving as obstacle anticipation assist control.

FIG. 6B shows a plan view of an object and a host vehicle for describing deceleration control serving as obstacle anticipation assist control.

FIG. 7A shows a steering control region.

FIG. 7B shows a host vehicle traveling region.

FIG. 7C shows a deceleration control region.

FIG. 8A shows a plan view of a guardrail, a two-wheel vehicle, and a host vehicle.

FIG. 8B shows a first range and a second range in the embodiment.

FIG. 8C shows a first range in the comparative example.

FIG. 9 is a flowchart showing a routine executed by the CPU of the driving assistance ECU shown in FIG. 1.

FIG. 10 is a graph showing first to third ranges of the embodiment.

FIG. 11 is a flowchart showing a routine executed by the CPU of the driving assistance ECU shown in FIG. 1.

FIG. 12 is a flowchart showing a routine executed by the CPU1 of the driving assistance ECU according to the first modified embodiment.

FIG. 13 is a flowchart showing a routine executed by the CPU2 of the driving assistance ECU according to the second modified embodiment.

FIG. 14 is a flowchart showing a routine executed by the CPU2 of the driving assistance ECU according to the second modified embodiment and the CPU3 of the driving assistance ECU according to the third modified embodiment.

FIG. 15 is a flowchart showing a routine executed by the CPU3 of the driving assistance ECU according to the third modified embodiment.

### DETAILED DESCRIPTION

### (Configuration)

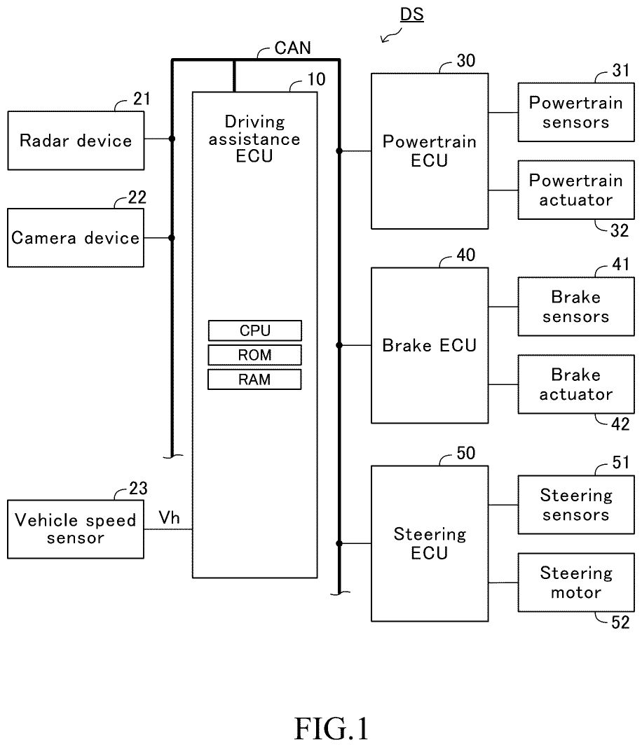

A driving assistance apparatus (hereinafter, referred to as a “present assistance apparatus”) DS according to an embodiment of the present disclosure, shown in FIG. 1, is mounted on the host vehicle. The host vehicle may be any one of a vehicle having an internal combustion engine as a driving source, a vehicle having an electric motor as a driving source (i.e., an electric vehicle), and a hybrid vehicle.

The present assistance apparatus DS comprises a driving assistance ECU 10, a powertrain ECU 30, a brake ECU 40, and a steering ECU 50. These ECUs are connected to each other via Controller Area Network (CAN) which is an in-vehicle communication network so as to be capable of exchanging information with each other. An “ECU” is an abbreviation of an electronic control unit, and may sometimes be referred to as a “controller” or a “computer”. An ECU is an electronic control circuit that includes, as a main component, a microcomputer. The microcomputer includes a CPU (a processor), a ROM, a RAM, and an interface. The CPU implements various functions by executing instructions (programs, routines) stored in the ROM. It should be noted that some or all of the above-described ECUs and unillustrated ECUs may be integrated into a single ECU. In addition, any one of the above-described ECUs and unillustrated ECUs may be implemented by a plurality of ECUs.

The driving assistance ECU 10 is configured to perform obstacle anticipation assist (OAA) control (i.e., Predictive Obstacle Assist Control) described later as the driving assistance control. The obstacle anticipation assist control is control to reduce the risk that the host vehicle will collide with an object moving at a relatively low speed such as a pedestrian and a two-wheel vehicle (e.g., a bicycle). The obstacle anticipation assist control includes deceleration control and steering control, in order to reduce the risk of a collision between the host vehicle and the object moving at a relatively low speed. This risk is sometimes referred to as a collision risk.

The present assistance apparatus DS comprises a radar device 21 and a camera device 22. A group of the radar device 21 and the camera device 22 is also collectively referred to as an object information obtaining device or an object detection device. The radar device 21 and the camera device 22 are connected to the driving assistance ECU 10 via the CAN so as to exchange information with each other. In addition, the driving assistance ECU 10 is connected with a vehicle speed sensor 23 configured to detect a speed of the host vehicle (i.e., a host vehicle speed Vh) so as to receive an output signal from the vehicle speed sensor 23.

The radar device 21 is a known device configured to obtain information on an object present ahead of the host vehicle using electric waves (radar waves or millimeter waves) in a millimeter wave band. The radar device 21 includes an unillustrated radar transmitting and receiving part and an unillustrated radar ECU.

The radar transmitting and receiving part is configured to transmit the millimeter waves in a predetermined detection area ahead of the host vehicle and to receive the millimeter waves reflected by the object ahead of the host vehicle. The radar transmitting and receiving part is configured to transmit information on the transmitted millimeter waves and the received millimeter waves to the radar ECU.

The radar ECU is configured to obtain the radar object information based on the information transmitted from the radar transmitting and receiving part and to transmit the radar object information to the driving assistance ECU 10.

The object information including the radar object information is represented using an X-Y coordinate system. In this X-Y coordinate system, the X-coordinate axis extends in the longitudinal (front-rear) direction of the host vehicle and passes through the center of the host vehicle in the vehicle-width direction. The Y-coordinate axis of the X-Y coordinate system is an axis orthogonal to the X-coordinate axis. The origin of the X-Y coordinate system is located at a position at the center of the host vehicle in the vehicle-width direction at the front end of the host vehicle. An X-coordinate value corresponding to a position located forward of the host vehicle with respect to the origin is a positive value, and an X-coordinate value corresponding to a position located rearward of the host vehicle with respect to the origin is a negative value. A Y-coordinate value corresponding to a position located to the left of the host vehicle with respect to the origin is a positive value, and a Y-coordinate value corresponding to a position located to the right of the host vehicle with respect to the origin is a negative value. In the present specification, a ground speed in the positive X-axis direction (i.e., the forward direction of the host vehicle) is defined as a positive ground speed, and a ground speed in the negative X-axis direction (i.e., the rearward direction of the host vehicle) is defined as a negative ground speed. It should be noted that the ground speed is defined as a speed in the X-axis direction of the host vehicle. A relative speed of an object is a positive value when the object is moving away from the host vehicle in the X-axis direction, and is a negative value when the object is coming closer to the host vehicle in the X-axis direction.

The radar object information includes, for example, a longitudinal position of the object relative to the host vehicle (which is an X-coordinate value of the object and is also referred to as a longitudinal distance), a lateral position of the object relative to the host vehicle (a Y-coordinate value of the object), a relative speed of the object Vrelative, and a ground speed of the object (hereinafter, also referred to as a “radar ground speed”) Vra. The radar ECU is configured to obtain a lateral position of the object based on an azimuth of the object with respect to the host vehicle and the longitudinal position of the object. The radar ECU is configured to obtain a radar ground speed Vra of the object based on the relative speed of the object Vrelative and the host vehicle speed Vh.

It should be noted that the radar device 21 may include a front-leftward radar device and a front-rightward radar device in addition to the frontward radar device which is the above described radar device. The radar object information obtained by those radar devices is fused by, for example, the radar ECU of the frontward radar device.

The camera device 22 includes an unillustrated camera and an unillustrated camera ECU. The camera is a monocular camera, and is configured to capture a scene ahead of the host vehicle at predetermined time intervals to obtain image data of captured images.

The camera ECU is configured to recognize (or detect) a left demarcation (boundary) line and a right demarcation (boundary) line of a host lane in which the host vehicle is traveling based on the image data from the camera. It should be noted that a demarcation line of a lane is typically a lane boundary line (i.e., a lane marker), and is, for example, a white or yellow line. The camera ECU is configured to obtain a position and a direction of the host vehicle with respect to the detected lane boundary line as lane boundary line information.

Furthermore, the camera ECU is configured to obtain the camera object information based on the image data from the camera. The camera object information includes a type (kind), a position (i.e., a longitudinal position and a lateral position), and a ground speed (hereinafter, also referred to as a camera ground speed) Vca of an object present ahead of the host vehicle.

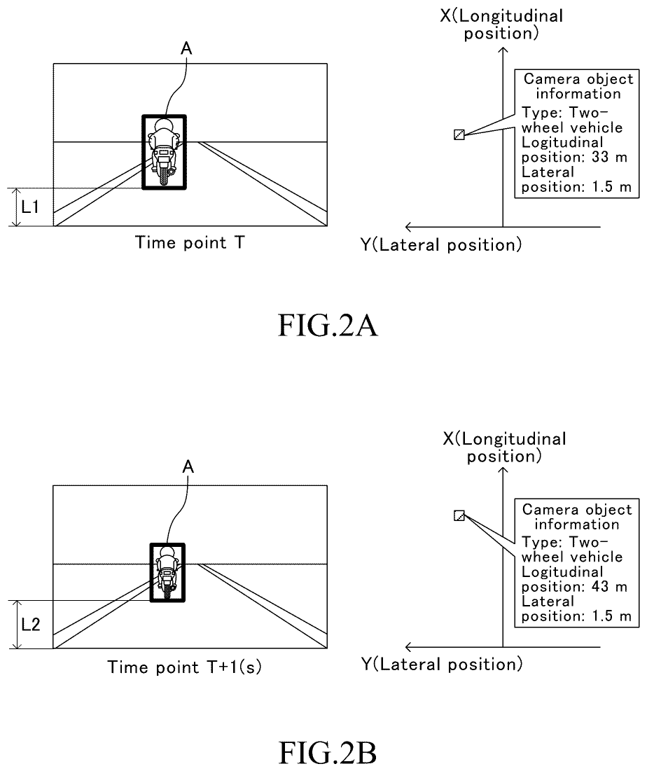

Specifically, as shown in FIG. 2A, the camera ECU obtains a longitudinal position X1 from the host vehicle to the object A based on the position L1 of the object A in the upper-lower direction (longitudinal direction) included in the captured image which the camera ECU obtains at a time point T. In addition, as shown in FIG. 2B, the camera ECU obtains a longitudinal position X2 from the host vehicle to the object A based on the position L2 of the object A in the upper-lower direction (longitudinal direction) included in the captured image which the camera ECU obtains at a time point T2 that is a predetermined time (e.g., 1 s) after the time point T. Thereafter, the camera ECU obtains the relative speed Vcr of the object A with respect to the host vehicle based on a difference between the longitudinal position X2 and the longitudinal position X1. Furthermore, the camera ECU obtains the camera ground speed Vca based on the relative speed Vcr and the host vehicle speed Vh.

The camera ECU obtains a type of the object A based on the known pattern matching method or the like. The type of the object includes a pedestrian, a two-wheel vehicle (i.e., a bicycle and a motorcycle), and a vehicle.

The camera ECU transmits the lane boundary line information and the camera object information to the driving assistance ECU 10.

The driving assistance ECU 10 fuses the radar object information and the camera object information to generate fusion object information that is final object information on the object present ahead of the host vehicle. It should be noted that either the radar ECU or the camera ECU may generate the fusion object information in place of the driving assistance ECU 10, and may transmit the fusion object information to the driving assistance ECU 10.

Specifically, the driving assistance ECU 10 regards an object indicated by the radar object information and an object indicated by the camera object information as the same object when a distance between a position of the object indicated by the radar object information and a position of the object indicated by the camera object information is equal to or less than a predetermined distance threshold. The driving assistance ECU 10 adopts, for the object regarded as the same object, a longitudinal position, a lateral position, a ground speed, and a relative speed included in the radar object information as a longitudinal position, a lateral position, a ground speed, and a relative speed of the object included in the fusion object information, respectively. The driving assistance ECU 10 adopts, as a type of the object in the fusion object information, a type of the object included in the camera object information for the object regarded as the same object.

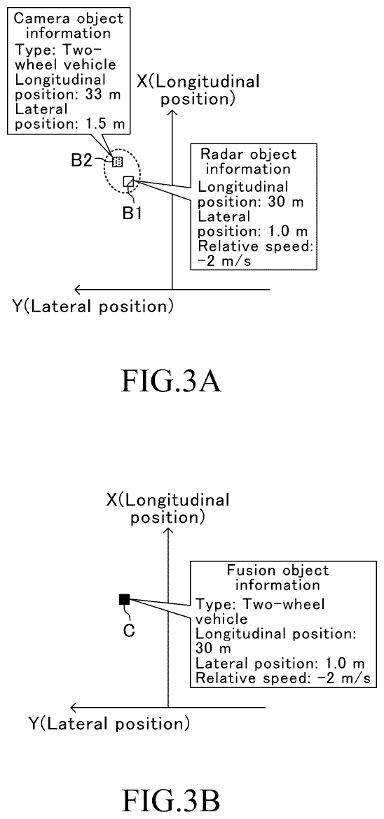

For example, it is assumed that the radar object information on the object B1 is obtained and the camera object information on the object B2 is obtained, as shown in FIG. 3A. In addition, it is assumed that information described below is contained in the respective obtained information.

### (Radar Object Information)

Longitudinal position: 30 m
Lateral position: 1 m
Relative speed Vrelative: −2 m/s
Radar ground speed: 50 km/h

### (Camera Object Information)

Type: two-wheel vehicle
Longitudinal position: 33 m
Lateral position: 1.5 m
Camera ground speed: 48 km/h

In this case, the position of the object B1 included in (indicated by) the radar object information is close to the position of the object B2 included in (indicated by) the camera object information, and a distance therebetween is short (i.e., equal to or less than a distance threshold Dth). Thus, the driving assistance ECU 10 regards the object B1 and the object B2 as the same object C and obtains the fusion object information, as described below, of the object C by fusing the radar object information with the camera object information.

### (Fusion Object Information)

Type: two-wheel vehicle (camera object information)
Longitudinal position: 30 m (radar object information)
Lateral position: 1 m (radar object information)
Relative speed Vrelative: −2 m/s (radar object information)
Fusion ground speed: 50 km/h (radar object information)

Referring back to FIG. 1, the powertrain ECU 30 receives detection signals from the powertrain sensors 31 including an accelerator pedal operation amount sensor. The powertrain ECU 30 drives the powertrain actuator 32 to control an unillustrated driving source (e.g., an internal combustion engine and/or an electric motor) of the host vehicle, to thereby adjust the driving force of the host vehicle.

The brake ECU 40 receives detection signals from the brake sensors 41 including a brake pedal operation amount sensor. The brake ECU 40 drives the brake actuator 42 to control an unillustrated brake device of the host vehicle, to thereby adjust the braking force applied to the host vehicle.

The steering ECU 50 receives detection signals from the steering sensors 51 including a steering torque sensor and a steering angle sensor. The steering ECU 50 drives the steering actuator 52 to control an unillustrated steering device of the host vehicle, to thereby alter the steering angle or a steering reaction force of the host vehicle.

(Outline of operation)

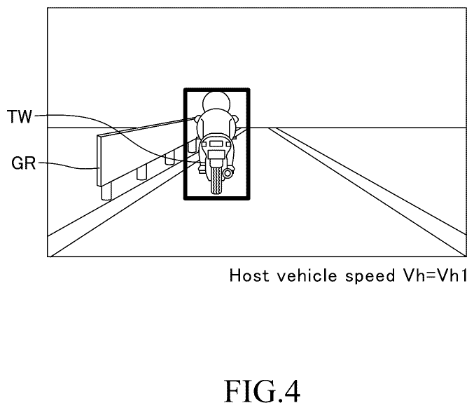

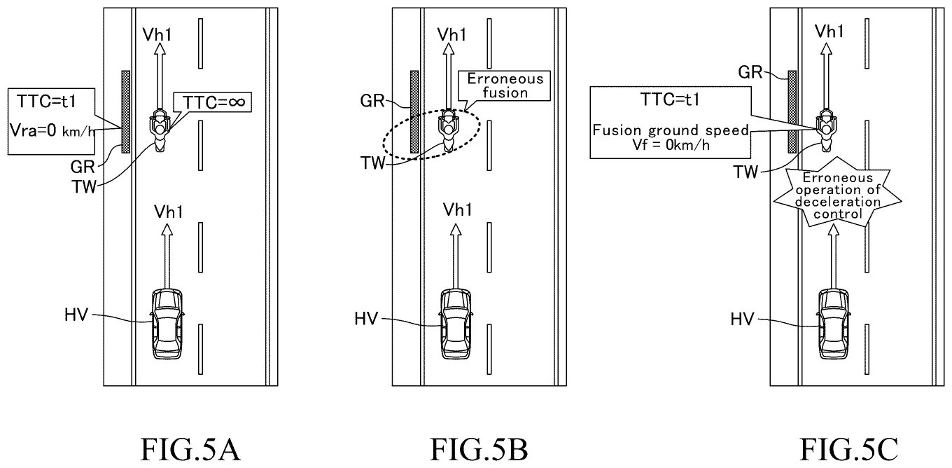

The inventors have found that the erroneous fusion may occur when two different objects are regarded as a single object, as described below. For example, as shown in FIG. 4 and FIG. 5A, there is a case in which, ahead of the host vehicle HV traveling at a certain speed Vh1 (e.g., 50 km/h), a two-wheel vehicle (in this example, a motorcycle) TW is traveling at the speed Vh1 that is equal to the speed of the host vehicle HV. In this case, the risk that the host vehicle HV collides with the two-wheel vehicle TW is considerably low. Therefore, it is not necessary to perform the obstacle anticipation assist control (the deceleration control or the steering control) to reduce the collision risk.

However, since the guardrail GR contains a lot of metallic portions, a case may occur in which the radar device 21 detects the guardrail GR but does not detect the two-wheel vehicle TW. On the other hand, the camera device 22 recognizes the two-wheel vehicle TW as an object and determines that the type of the recognized object is a two-wheel vehicle. In this situation, as shown in FIG. 5B, since the position (i.e., the longitudinal distance and the lateral distance) of the guardrail GR included in the radar object information is close to the position (i.e., the longitudinal distance and the lateral distance) of the two-wheel vehicle TW included in the camera object information, the radar object information on the guardrail GR and the camera object information on the two-wheel vehicle TW are erroneously fused with each other. Namely, in such a situation, an erroneous fusion occurs.

As a result, the fusion object information becomes information that indicates that the type of the object is a two-wheel vehicle and the fusion ground speed Vf representing the ground speed of the object is the radar ground speed Vra of the guardrail GR which is 0 km/h. Consequently, the driving assistance ECU 10 determines that the risk of collision between the host vehicle HV and the two-wheel vehicle TW is relatively high, thereby performing the obstacle anticipation assist control as shown in FIG. 5C.

In view of the above, the present assistance apparatus is configured not to perform the obstacle anticipation assist control with respect to the object represented by the fusion object information that has been erroneously fused based on a technique, described later, that utilizes the camera ground speed Vca that has not been utilized in the conventional apparatus due to insufficient accuracy. More specifically, the present assistance apparatus is configured to perform (permit) the obstacle anticipation assist control when a specific state is occurring in which the fusion ground speed is within a first range including 0 and the camera ground speed is within a second range including 0. The first range and the second range will be described later in detail.

### (Obstacle Anticipation Assist Control: OAA)

To facilitate understanding of the operation of the present assistance apparatus DS, an overview of the obstacle anticipation assist control performed by the present assistance apparatus DS will first be described. As mentioned above, the obstacle anticipation assist control includes the steering control and the deceleration control.

### 1. Steering Control

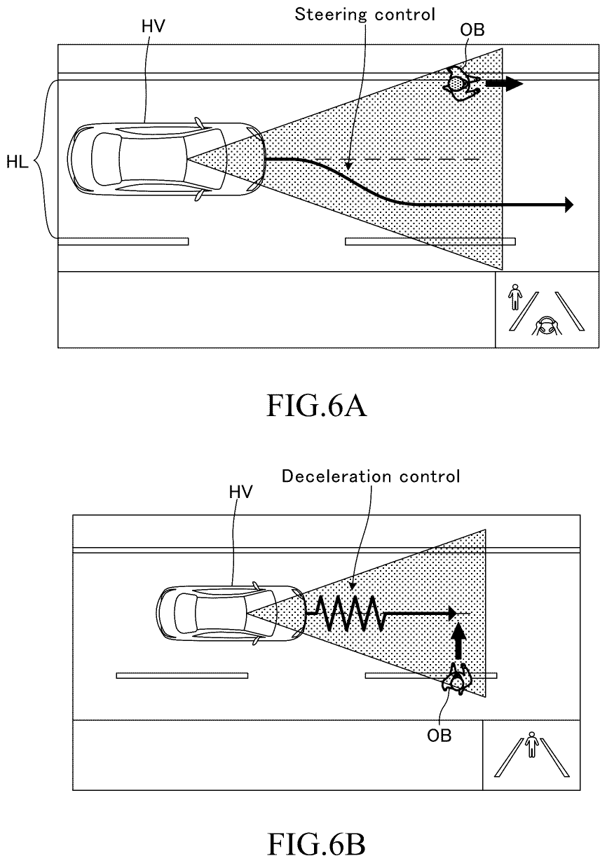

As shown in FIG. 6A, the driving assistance ECU 10 alters the steering angle of the host vehicle HV in such a manner that the host vehicle HV is kept within a range of the host lane HL and the host vehicle moves away from the object OB when either a first steering condition described below or a second steering condition described below is satisfied. This is the steering control of the obstacle anticipation assist control.

### <First Steering Condition>

The first steering condition is satisfied when all of the following conditions S1 to S5 are satisfied.

Condition S1: The type of the object OB present ahead of the host vehicle HV is either a pedestrian or a two-wheel vehicle.

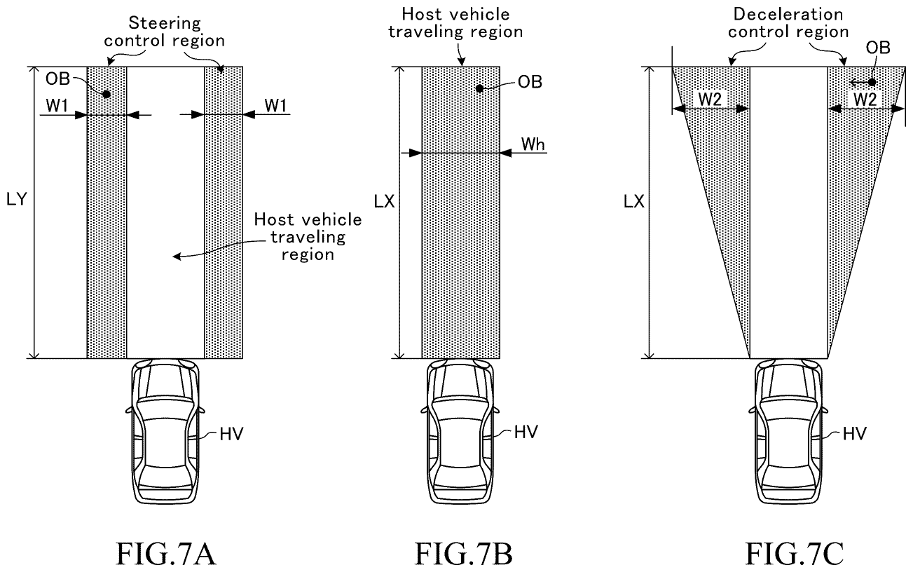

Condition S2: A part or a whole of the object OB is located within a steering control region shown in FIG. 7A and is not located within a host vehicle traveling region shown in FIG. 7B. The steering control region is set in the vicinity outside of the host vehicle traveling region.

Condition S3: The object OB does not have a lateral speed in a direction toward (approaching) the host vehicle traveling region (e.g., a lateral velocity having a component that causes the object OB to intersect with a line extending along host vehicle traveling direction).

Condition S4: The fusion ground speed Vf (that is equal to the radar ground speed Vra) of the object OB is equal to or greater than a first speed threshold VfLoth smaller than 0 (i.e., negative) and is equal to or smaller than a second speed threshold VfHith greater than 0 (i.e., positive). It should be noted that a magnitude of the first speed threshold VfLoth may be equal to or different from a magnitude of the second speed threshold VfHith. A range that is equal to or greater than the first speed threshold VfLoth and is equal to or smaller than the second speed threshold VfHith is a range that includes 0 and is also referred to as the first range.

Condition S5: The object OB and the host vehicle HV are coming closer to each other (i.e., the relative speed Vrelative of the object OB is negative) and a time to collision (i.e., a predicted collision time) TTC is equal to or smaller than a first time threshold TTC1th.

The time to collision TTC is a time for a longitudinal distance (i.e., the distance in the X-axis direction) between the host vehicle HV and the object OB to reach 0 on the assumption that the host vehicle HV and the object OB maintain their current speeds and their current traveling directions, respectively. The time to collision TTC is obtained by dividing the longitudinal distance between the host vehicle HV and the object OB (i.e., the longitudinal position of the object OB) by the relative speed Vrelative of the object OB.

### <Second Steering Condition>

The second steering condition is satisfied when all of the following conditions U1 to U5 are satisfied.

Condition U1: The type of the object OB present ahead of the host vehicle HV is a vehicle.

Condition U2: A part or a whole of the object OB is located within the steering control region and the remaining part of the object OB is not located within the host vehicle traveling region.

Condition U3: The object OB does not have a lateral speed in a direction toward (approaching) the host vehicle traveling region.

Condition U4: The fusion ground speed Vf (that is equal to the radar ground speed Vra) of the object OB is equal to 0.

Condition U5: The time to collision between the object OB and the host vehicle HV is equal to or smaller than the first time threshold TTC1th.

### 2. Deceleration Control

The driving assistance ECU 10 relatively moderately decelerates the host vehicle HV as shown in FIG. 6B, when either a first deceleration condition described below or a second deceleration condition described below is satisfied. This is the deceleration control of the obstacle anticipation assist control.

### <First Deceleration Condition>

The first deceleration condition is satisfied when all of the following conditions V1 to V4 are satisfied.

Condition V1: The type of the object OB present ahead of the host vehicle HV is one of a pedestrian, a two-wheel vehicle, and a vehicle.

Condition V2: A part or a whole of the object OB is located within the host vehicle traveling region shown in FIG. 7B.

Condition V3: The fusion ground speed Vf (that is equal to the radar ground speed Vra) of the object OB is equal to or greater than the first speed threshold VfLoth and is equal to or smaller than the second speed threshold VfHith. Namely, the fusion ground speed Vf is within the first range.

Condition V4: The time to collision between the object OB and the host vehicle HV is equal to or smaller than a second time threshold TTC2th. The second time threshold TTC2th may be the same as or different from the first time threshold TTC1th.

### <Second Deceleration Condition>

The second deceleration condition is satisfied when all of the following conditions W1 to W5 are satisfied.

Condition W1: The type of the object OB present ahead of the host vehicle HV is either a pedestrian or a two-wheel vehicle.

Condition W2: A part or a whole of the object OB is located within a deceleration control region shown in FIG. 7C and the remaining part of the object OB is not located within the host vehicle traveling region.

Condition W3: The object OB has a lateral speed in the direction toward (approaching) the host vehicle traveling region.

Condition W4: The fusion ground speed Vf (that is equal to the radar ground speed Vra) of the object OB is equal to or greater than the first speed threshold VfLoth and is equal to or smaller than the second speed threshold VfHith. Namely, the fusion ground speed Vf is within the first range.

Condition W5: The time to collision between the object OB and the host vehicle HV is equal to or smaller than the second time threshold TTC2th.

### (Prevention of the Erroneous Obstacle Anticipation Assist Control Due to the Erroneous Fusion)

As described above, when the fusion object information is obtained, the driving assistance ECU 10 determines, utilizing the camera ground speed Vca which has not been utilized in the conventional apparatus, whether an object represented by (or corresponding to) the fusion object information is not an object represented by the erroneously fused object but is a valid object as an object to be subject to the obstacle anticipation assist control.

More specifically, an object to be subjected to the obstacle anticipation assist control is a “relatively low-speed moving object” whose fusion ground speed Vf (i.e., the radar ground speed Vra) is equal to or greater than the first speed threshold VfLoth which is negative and equal to or smaller than the second speed threshold VfHith which is positive (see the above-described Conditions S4, U4, V3, and W4).

However, as described above, when the erroneous fusion occurs, for example, the fusion ground speed Vf (i.e., the radar ground speed Vra) of the object whose actual ground speed is greater than the second speed threshold VfHith may be less than the second speed threshold VfHith. In contrast, even when the erroneous fusion occurs, the camera ground speed Vca of the object whose actual ground speed is greater than the second speed threshold VfHith is close to the actual ground speed. Therefore, it can be determined that the object whose camera ground speed Vca is greater than a value in the vicinity of the second speed threshold VfHith is not a valid object to be subjected to the obstacle anticipation assist control. The same applies to an object whose actual ground speed is smaller than the first speed threshold VfLoth. Namely, even when the fusion ground speed Vf (i.e., the radar ground speed Vra) of the object whose actual ground speed is less than the first speed threshold VfLoth is greater than the first speed threshold VfLoth, the camera ground speed Vca of that object is less than a value in the vicinity of the first speed threshold VfLoth if the erroneous fusion is occurring. Therefore, it can be determined that the object whose camera ground speed Vca is less than a value in the vicinity of the first speed threshold VfLoth is not a valid object to be subjected to the obstacle anticipation assist control.

In view of the above, the driving assistance ECU 10 basically treats the object W as the object to be subjected to the obstacle anticipation assist control, wherein the object W is an object whose fusion ground speed Vf (i.e., the radar ground speed Vra) is equal to or greater than the first speed threshold VfLoth and is equal to or smaller than the second speed threshold VfHith, and whose camera ground speed Vca is equal to or greater than a third speed threshold VcaNLth smaller than 0 and is equal to or smaller than a fourth speed threshold VcaNHth greater than 0. It should be noted that the third speed threshold VcaNLth is set at a value substantially equal to the first speed threshold VfLoth, and the fourth speed threshold VcaNHth is set at a value substantially equal to the second speed threshold VfHith.

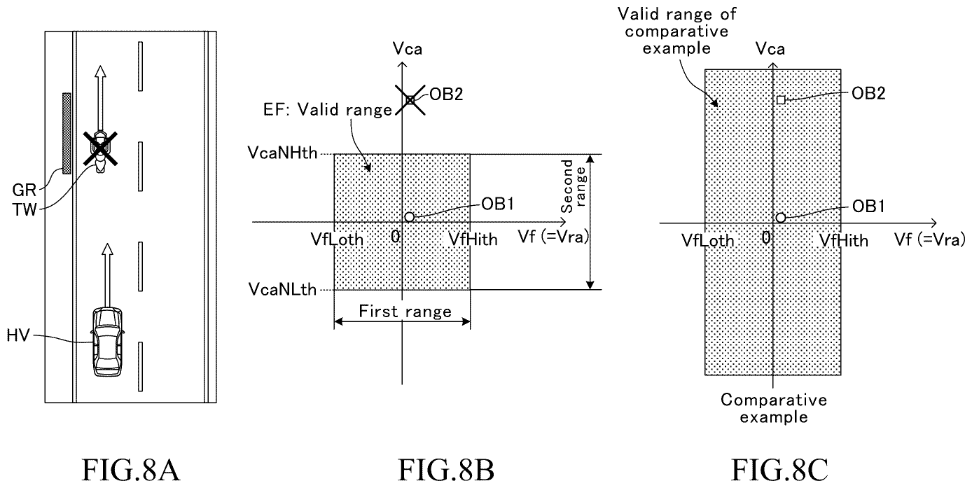

A range that is equal to or greater than the third speed threshold VcaNLth and is equal to or smaller than the fourth speed threshold VcaNHth may also be referred to as a second range. Thus, the driving assistance ECU 10 basically treats the object whose fusion ground speed Vf is within the first range and whose camera ground speed Vca is within the second range (refer to an object within a valid range EF shown in FIG. 8B) as the object to be subjected to the obstacle anticipation assist control.

As a result, as shown in FIG. 8B which represents the present embodiment and FIG. 8C which represents a comparative example, in both the present embodiment and the comparative example, the object OB1 whose fusion object information is not erroneously fused and is moving at a relatively low speed is treated as an object to be subjected to the obstacle anticipation assist control. In contrast, the object OB2 whose fusion object information is erroneously fused is treated as an object to be subjected to the obstacle anticipation assist control in the comparative example as shown in FIG. 8C, whereas the object OB2 is not treated as an object to be subjected to the obstacle anticipation assist control in the present embodiment as shown in FIG. 8B. Accordingly, the driving assistance ECU 10 of the present assistance apparatus can reduce the possibility of erroneously performing the obstacle anticipation assist control due to the erroneous fusion.

### (Specific Operation)

### 1. Update of a Value of a Counter

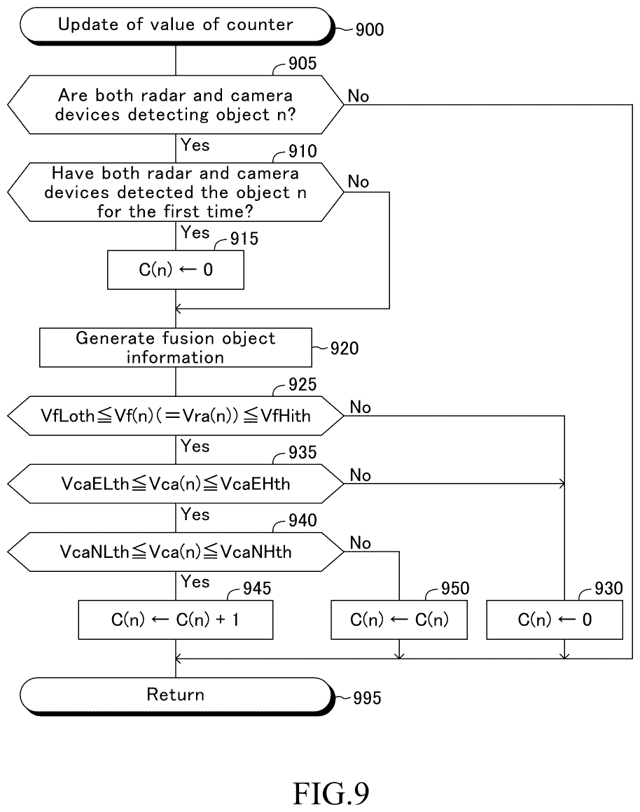

The CPU of the driving assistance ECU 10 (hereinafter, simply referred to as a “CPU”) is configured to execute a routine shown in a flowchart in FIG. 9, each time a predetermined time elapses. This routine causes a value of a counter C(n) to be updated. As described later, when the value of the counter C(n) is equal to or greater than a counter threshold Cth, an object n is treated as an object to be subjected to the obstacle anticipation assist control. When the value of the counter C(n) is less than the counter threshold Cth, an object n is not treated as an object to be subjected to the obstacle anticipation assist control. Hereinafter, a step is referred to as S.

When an appropriate time point comes, the CPU starts processing from S900 in FIG. 9, and proceeds to S905. At S905, the CPU determines whether both the radar device 21 and the camera device 22 detect an object n. When at least one of the radar device 21 and the camera device 22 does not detect the object n (i.e., when only one of them detects the object n or when none of them detects the object n), the CPU makes a “No” determination at S905 to directly proceed to S995 to terminate the present routine.

In contrast, when both the radar device 21 and the camera device 22 detect an object n, the CPU makes a “Yes” determination at S905 to proceed to S910. At S910, the CPU determines whether or not the present time is immediately after a time point at which both the radar device 21 and the camera device 22 have detected the object n for the first time.

When the present time is immediately after the time point at which both the radar device 21 and the camera device 22 have detected the object n for the first time, the CPU makes a “Yes” determination at S910 to proceed to S915. At S915, the CPU sets the value of the counter C(n) to 0 and proceeds to S920. In contrast, when the present time is not immediately after the time point at which both the radar device 21 and the camera device 22 have detected the object n for the first time, the CPU makes a “No” determination at S910 to directly proceed to S920.

At S920, the CPU generates the fusion object information based on the radar object information and the camera object information, as described above. Thereafter, the CPU proceeds to S925.

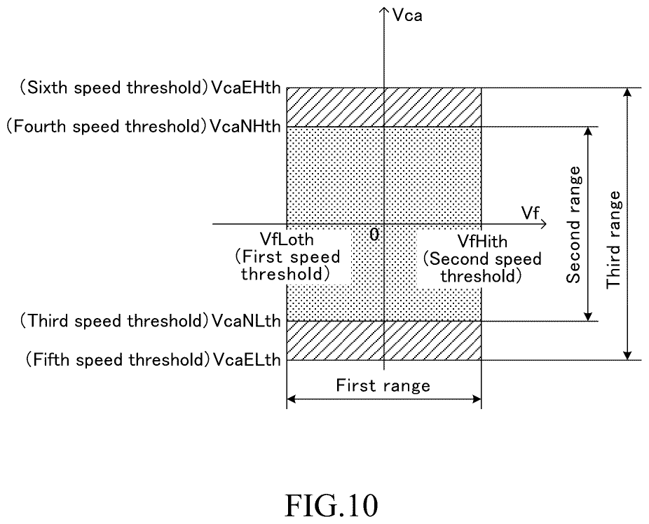

At S925, the CPU determines whether or not the fusion ground speed Vf(n) of the object n is equal to or greater than the first speed threshold VfLoth and is equal to or less than the second speed threshold VfHith (refer to FIG. 8B and FIG. 10). That is, the CPU determines whether or not the fusion ground speed Vf(n) is within the first range. It should be noted that, as described above, the radar ground speed Vra(n) is adopted as the fusion ground speed Vf(n).

When the fusion ground speed Vf(n) is not within the first range (namely, when the fusion ground speed Vf(n) is smaller than the first speed threshold VfLoth or is greater than the second speed threshold VfHith), the CPU makes a “No” determination at S925 to proceed to S930. At S930, the CPU sets the value of the counter C(n) to 0. Thereafter, the CPU proceeds to S995 to terminate the present routine tentatively.

In contrast, when the fusion ground speed Vf(n) is within the first range, the CPU makes a “Yes” determination at S925 to proceed to S935. At S935, the CPU determines whether or not the camera ground speed Vca(n) is equal to or greater than a fifth speed threshold VcaELth and is equal to or less than a sixth speed threshold VcaEHth (refer to FIG. 10). The fifth speed threshold VcaELth is smaller than the third speed threshold VcaNLth by a predetermined small value. The sixth speed threshold VcaEHth is greater than the fourth speed threshold VcaNHth by a predetermined small value. It should be noted that a range that is equal to or greater than the fifth speed threshold VcaELth and is equal to or smaller than the sixth speed threshold VcaEHth may also be referred to as a third range. Thus, at S935, the CPU determines whether or not the camera ground speed Vca(n) of the object n is within the third range.

When the camera ground speed Vca(n) of the object n is not within the third range (i.e., when the camera ground speed Vca(n) is smaller than the fifth speed threshold VcaELth or is greater than the sixth speed threshold VcaEHth), the CPU makes a “No” determination at S935 to proceed to S930. At S930, the CPU sets the value of the counter C(n) to 0. Thereafter, the CPU proceeds to S995 to terminate the present routine tentatively.

In contrast, when the camera ground speed Vca(n) of the object n is within the third range, the CPU makes a “Yes” determination at S935 to proceed to S940. At S940, the CPU determines whether or not the camera ground speed Vca(n) is equal to or greater than the third speed threshold VcaNLth and is equal to or less than the fourth speed threshold VcaNHth (refer to FIG. 10). That is, at S940, the CPU determines whether or not the camera ground speed Vca(n) of the object n is within the second range.

When the camera ground speed Vca(n) of the object n is within the second range, the CPU makes a “Yes” determination at S940 to proceed to S945. At S945, the CPU increments the value of the counter C(n) by 1. Thereafter, the CPU proceeds to S995 to terminate the present routine tentatively.

In contrast, when the camera ground speed Vca(n) of the object n is not within the second range, the CPU makes a “No” determination at S940 to proceed to S950. At S950, the CPU maintains the value of the counter C(n) at the current value. Thereafter, the CPU proceeds to S995 to terminate the present routine tentatively.

The reason why the third range is set at a range wider than the second range and the CPU maintains the value of the counter C(n) at S950 when the camera ground speed Vca(n) is within the third range (S935: Yes) but is not within the second range (S940: No) is that it is taken into consideration that the accuracy of the camera ground speed Vca(n) is not sufficiently high.

### 2. Obstacle Anticipation Assist (OAA) Control

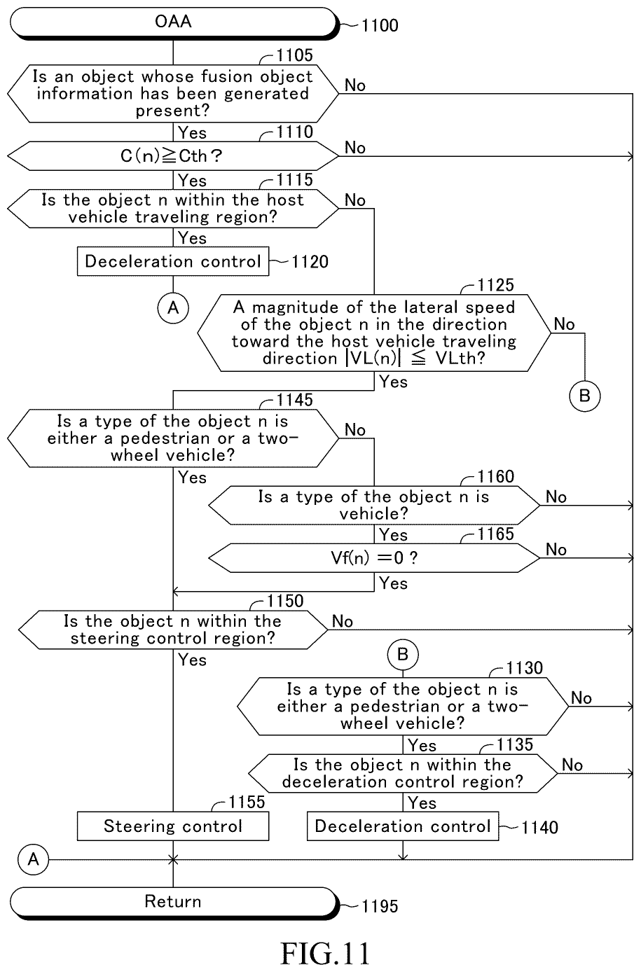

The CPU is configured to execute a routine shown in a flowchart in FIG. 11, each time a predetermined time elapses. This routine causes the obstacle anticipation assist control to be performed when a predetermined condition is satisfied.

When an appropriate time point comes, the CPU starts processing from S1100 in FIG. 11, and proceeds to S1105. At S1105, the CPU determines whether or not an object n whose fusion object information has been generated is present (refer to S920). When the object n whose fusion object information has been generated is not present, the CPU makes a “No” determination at S1105 to directly proceed to S1195. At S1195, the CPU terminates the present routine tentatively.

In contrast, when the object n whose fusion object information has been generated is present, the CPU makes a “Yes” determination at S1105 to proceed to S1110. At S1110, the CPU determines whether or not the value of the counter C(n) is equal to or greater than the counter threshold Cth. That is, the CPU determines whether or not the object n is an object to be subjected to the obstacle anticipation assist control.

When the value of the counter C(n) is less than the counter threshold Cth, the CPU makes a “No” determination at S1110 to directly proceed to S1195. At S1195, the CPU terminates the present routine tentatively.

In contrast, when the value of the counter C(n) is equal to or greater than the counter threshold Cth, the CPU makes a “Yes” determination at S1110 to proceed to S1115. At S1115, the CPU determines whether or not a part of the object n is located within the host vehicle traveling region shown in FIG. 7B.

The width Wh of the host vehicle traveling region is equal to or slightly longer than the width of the host vehicle HV. The length LX in the X-axis direction of the host vehicle traveling region becomes longer as the relative speed Vrelative of the object n with respect to the host vehicle HV becomes higher. More specifically, the length LX is a length at which the predicted collision time TTC becomes the second time threshold TTC2th (for example, 4 seconds).

When a part (or a whole) of the object n is located within the host vehicle traveling region, the CPU makes a “Yes” determination at S1115 to proceed to S1120. At S1120, the CPU performs the deceleration control. More specifically, the CPU transmits an instruction signal to the brake ECU to thereby decelerate the host vehicle HV at a relatively small target deceleration (Dtgt). As a result, the brake actuator 42 is driven and the vehicle HV moderately decelerates at a deceleration equal to the target deceleration. Thereafter, the CPU directly proceeds to S1195 to terminate the present routine tentatively.

When a part (or a whole) of the object n is not located within the host vehicle traveling region, the CPU makes a “No” determination at S1115 to proceed to S1125. At S1125, the CPU determines whether or not a magnitude |VL(n)| of the lateral speed VL(n) of the object n in the direction toward the host vehicle traveling direction is equal to or smaller than a lateral speed threshold VLth. The lateral speed threshold VLth is 0 or a value extremely close to 0.

When the magnitude |VL(n)| of the object n in the direction toward the host vehicle traveling direction is greater than the lateral speed threshold VLth, the CPU makes a “No” determination at S1125 to proceed to S1130. At S1130, the CPU determines whether the type of the object n is either a pedestrian or a two-wheel vehicle. When the type of the object n is neither a pedestrian nor a two-wheel vehicle, the CPU makes a “No” determination at S1130 to directly proceed to S1195 to terminate the present routine tentatively.

When the type of the object n is either a pedestrian or a two-wheel vehicle, the CPU makes a “Yes” determination at S1130 to proceed to S1135. At S1135, the CPU determines whether or not a part of the object n is located within the deceleration control region shown in FIG. 7C.

The deceleration control region has a right triangular shape. A height W2 thereof becomes larger as a magnitude |VL(n)| of a lateral speed of the object n (refer to the object OB in FIG. 7C) in a direction toward the host vehicle traveling direction increases, and a length LX of a base thereof becomes larger as a relative speed Vrelative of the object n with respect to the host vehicle HV increases. More specifically, the length LX is a length at which a predicted collision time TTC becomes the second time threshold TTC2th (for example, 4 seconds).

When any part of the object n is not located in the deceleration control region, the CPU makes a “No” determination at S1135 to proceed to S1195 to terminate the present routine tentatively.

In contrast, when a part of the object n is located within the deceleration control region, the CPU makes a “Yes” determination at S1135 to proceed to S1140. At S1140, similarly to S1120, the CPU performs the deceleration control. Thereafter, the CPU proceeds to S1195.

On the other hand, when the CPU proceeds to S1125, if the magnitude |VL(n)| of the object n in the direction toward the host vehicle traveling direction is equal to or smaller than the lateral speed threshold VLth, the CPU makes a “Yes” determination at S1125 to proceed to S1145. At S1145, the CPU determines whether the type of the object n is either a pedestrian or a two-wheel vehicle.

When the type of the object n is either a pedestrian or a two-wheel vehicle, the CPU makes a “Yes” determination at S1145 to proceed to S1150. At S1150, the CPU determines whether or not a part of the object n is located within the steering control region shown in FIG. 7A.

The steering control region is a region set at both the left and right sides of the host vehicle traveling region and has a rectangular shape. The width W1 of the steering control region is about one-third of the width of the host vehicle. The length LY in the X-axis direction of the steering control region becomes larger as the relative speed Vrelative of the object n with respect to the host vehicle HV increases. More specifically, the length LY is a length at which a predicted collision time TTC becomes the first time threshold TTC1th (for example, 4 seconds).

When any part of the object n is not located in the steering control region, the CPU makes a “No” determination at S1150 to proceed to S1195 to terminate the present routine tentatively. In contrast, when a part of the object n is located in the steering control region, the CPU makes a “Yes” determination at S1150 to proceed to S1155. At S1155, the CPU performs the steering control as shown in FIG. 6A. That is, the CPU transmits an instruction signal to the steering ECU 50 to thereby cause the steering motor 52 serving as the steering actuator to be driven. This causes the steering angle of the host vehicle HV to be altered in such a manner that the host vehicle HV moves away from the object OB while the host vehicle is maintained within a range of the host lane HL. Thereafter, the CPU proceeds to S1195 to terminate the present routine tentatively. It should be noted that, at S1155, the CPU may drive the steering motor 52 in such a manner that the steering reaction force becomes the smallest in a case in which the host vehicle HV is maintained within the range of the host lane HL and moves away from the object OB.

When the CPU proceeds to S1145, the CPU makes a “No” determination at S1145 to proceed to S1160 if the type of the object is neither a pedestrian nor a two-wheel vehicle. At S1160, the CPU determines whether or not a type of the object n is a vehicle. When the type of the object n is not a vehicle, the CPU makes a “No” determination at S1160 to directly proceed to S1195.

In contrast, when the type of the object is a vehicle, the CPU makes a “Yes” determination at S1160 to proceed to S1165. At S1165, the CPU determines whether or not the object n (that is, the vehicle) is stopped (is in a stopped state) by determining whether or not the fusion ground speed Vf(n) is 0. When the object n is not stopped, the CPU makes a “No” determination at S1165 to directly proceed to S1195.

In contrast, when the object n is stopped (is in a stopped state), the CPU makes a “Yes” determination at S1165 to execute the above-described processes of S1150 and the following steps.

As has been described, according to the present assistance apparatus DS, the obstacle anticipation assist control serving as the driving assistance control is performed (S1120, S1140, S1155) with respect to the specific object n whose fusion object information has been generated in a case where a specific situation is occurring (S1110: Yes, i.e., C(n)?Cth) in which, or which indicates that, the fusion ground speed Vf(n) (i.e., the radar ground speed Vra(n)) of the object n is within the first range including 0 (S925: Yes) and the camera ground speed Vca(n) of the object n included in the camera object information is within the second range including 0 (S940: Yes), and the driving assistance control is not performed when the specific situation is not occurring (i.e., C(n)<Cth) (S1110: No). Accordingly, the present assistance apparatus DS is very unlikely to erroneously perform the obstacle anticipation assist control due to the erroneous fusion. It should be noted that the counter threshold Cth is preferably 2 or more, but may be 1.

The present assistance apparatus DS determines that the specific situation is occurring when a total amount of time, which corresponds to the value of the counter C(n), of a first state becomes equal to or greater than the time threshold, which corresponds to the counter threshold Cth, wherein the first state is a state in which the fusion ground speed Vf(n) is within the first range and the camera ground speed Vca(n) is within the second range while the camera ground speed Vca(n) of the object n continues to be within the third range including the second range. Thus, the present assistance apparatus DS can reduce the possibility that the obstacle anticipation assist control serving as the driving assistance control is not performed for an object which should be subjected to the obstacle anticipation assist control due to the insufficient accuracy of the camera ground speed Vca(n).

### First Modified Embodiment

Next, a first modified embodiment will be described. This first modified embodiment does not perform the process using the third range to update the value of the counter C(n). That is, the first modified embodiment is different from the above-described present assistance apparatus only in that it is configured to update the value of the counter C(n) only depending on whether or not the fusion ground speed Vf(n) is within the first range and whether or not the camera ground speed Vca(n) is within the second range. Hereinafter, this difference will be mainly described.

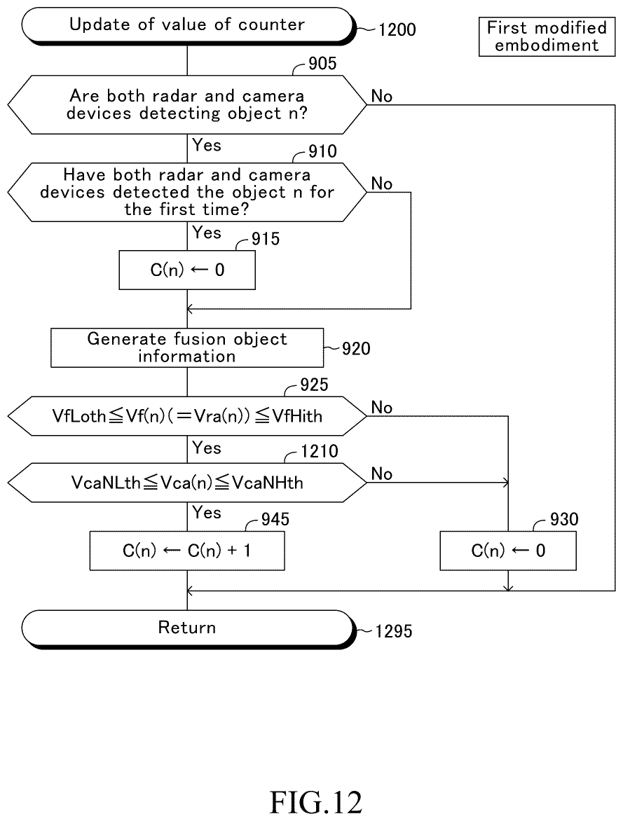

The CPU of the driving assistance ECU 10 of the first modified embodiment (hereinafter, referred to as a CPU1) is configured to execute a routine shown in a flowchart in FIG. 12 in place of FIG. 9. It should be noted that steps shown in FIG. 12 that perform the same processing as the steps shown in FIG. 9 are denoted by the same reference numerals as those shown in FIG. 9. Descriptions of such steps will be omitted as appropriate.

When an appropriate time point comes, the CPU starts processing from S1200 in FIG. 12, and executes appropriate processes from S905 to S925. Thus, when the fusion ground speed Vf(n) is not within the first range, the CPU1 proceeds from S925 to S930 to set the value of the counter C(n) to 0. Thereafter, the CPU1 proceeds to S1295 to terminate the present routine tentatively.

In contrast, when the fusion ground speed Vf(n) is within the first range, the CPU1 makes a “Yes” determination at S925 to proceed to S1210. At S1210, the CPU1 performs a process similarly to the process at S940. That is, at S1210, the CPU1 determines whether or not the camera ground speed Vca(n) of the object n is within the second range.

When the camera ground speed Vca(n) is within the second range, the CPU1 makes a “Yes” determination at S1210 to proceed to S945. At S945, the CPU1 increments the value of the counter C(n) by 1. Thereafter, the CPU1 proceeds to S1295 to terminate the present routine tentatively.

In contrast, when the camera ground speed Vca(n) is not within the second range, the CPU1 makes a “No” determination at S1210 to proceed to S930. At S930, the CPU1 sets the value of the counter C(n) to 0. Thereafter, the CPU1 proceeds to S1295 to terminate the present routine tentatively.

This makes the value of the counter C(n) a value representing the duration for which a second state continues (referred to as the continuing time TK), wherein the second state is a state in which the fusion ground speed Vf(n) is within the first range and the camera ground speed Vca(n) is within the second range. Therefore, when the continuing time TK of the second state is equal to or greater than the time threshold corresponding to the counter threshold Cth, the CPU1 determines that the object n is an object to be subjected to the obstacle anticipation assist control and performs the obstacle anticipation assist control as necessary.

According to the first modified embodiment, in a case where the continuing time TK (i.e., the duration corresponding to the value of the counter C(n)) of the second state, which is a state in which the fusion ground speed Vf(n) is within the first range and the camera ground speed Vca(n) is within the second range, is equal to or greater than the time threshold (i.e., the time corresponding to the counter threshold Cth), the obstacle anticipation assist control for the object n is performed. Accordingly, the first modified embodiment can also reduce the possibility that the obstacle anticipation assist control is erroneously performed due to the erroneous fusion. It should be noted that the counter threshold Cth is preferably 2 or more, but may be 1.

### Second Modified Embodiment

Next, a second modified embodiment will be described. This second modified embodiment is different from the above-described present assistance apparatus only in that it is configured to update the value of the counter C(n) only depending on the camera ground speed Vca(n) regardless of the fusion ground speed Vf(n) and to perform the obstacle anticipation assist control as necessary if the fusion ground speed Vf(n) is within the first range at a time point at which the value of the counter C(n) becomes equal to or greater than the counter threshold Cth. Hereinafter, this difference will be mainly described.

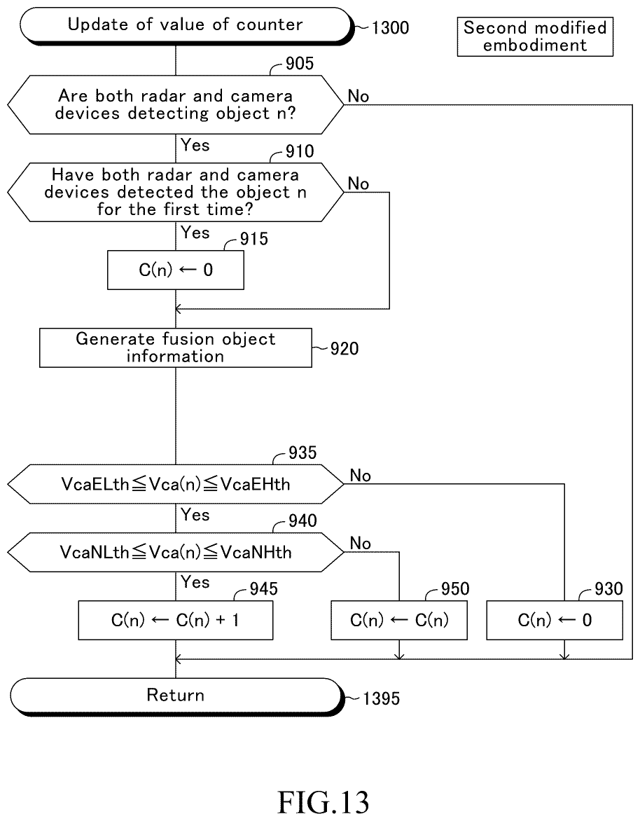

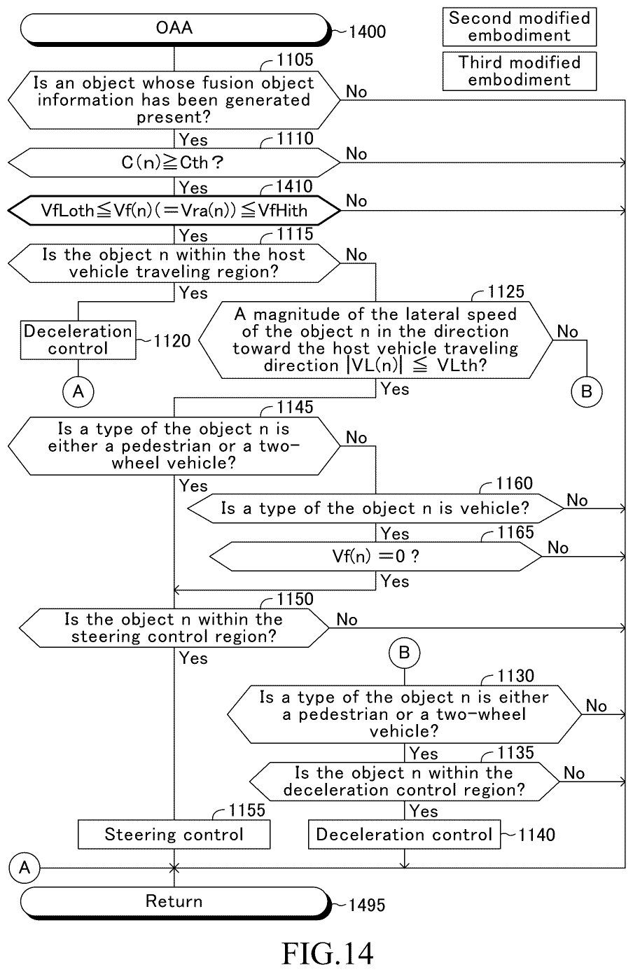

The CPU of the driving assistance ECU 10 of the second modified embodiment (hereinafter, referred to as a CPU2) is configured to execute a routine shown in a flowchart in FIG. 13 in place of FIG. 9 and a routine shown in a flowchart in FIG. 14 in place of FIG. 11. It should be noted that steps shown in FIG. 13 that perform the same processing as the steps shown in FIG. 9 are denoted by the same reference numerals as those shown in FIG. 9, and steps shown in FIG. 14 that perform the same processing as the steps shown in FIG. 11 are denoted by the same reference numerals as those shown in FIG. 11. Descriptions of such steps will be omitted as appropriate.

The routine shown in FIG. 13 is a routine obtained by omitting S925 from the routine shown in FIG. 9. That is, when an appropriate time point comes, the CPU starts processing from S1300 in FIG. 13, and executes appropriate processes from S905 to S920 shown in FIG. 13. Thus, after the CPU2 generates the fusion object information at S920, the CPU2 executes the processes of S935 and the following steps. This makes the value of the counter C(n) a value representing a cumulative time of a third state in which the camera ground speed Vca(n) is within the second range in a case where the camera ground speed Vca(n) remains within the third range that includes the second range.

The routine shown in FIG. 14 is a routine obtained by adding S1410 to the routine shown in FIG. 11. That is, when an appropriate time point comes, the CPU2 starts processing from S1400 in FIG. 14 to proceed to S1105. At S1105, the CPU2 determines whether or not an object whose fusion object information has been generated is present (refer to S920). When an object whose fusion object information has been generated is not present, the CPU2 makes a “No” determination at S1105 to directly proceed to S1495. At S1495, the CPU2 terminates the present routine tentatively.

In contrast, when an object whose fusion object information has been generated is present, the CPU2 makes a “Yes” determination at S1105 to proceed to S1110. At S1110, the CPU2 determines whether or not the value of the counter C(n) is equal to or greater than the counter threshold Cth. When the value of the counter C(n) is smaller than the counter threshold Cth, the CPU2 makes a “No” determination at S1110 to directly proceed to S1495. At S1495, the CPU2 terminates the present routine tentatively.

In contrast, when the value of the counter C(n) is equal to or greater than the counter threshold Cth, the CPU2 makes a “Yes” determination at S1110 to proceed to S1410. At S1410, the CPU2 determines whether or not the fusion ground speed Vf(n) is equal to or greater than the first speed threshold VfLoth and equal to or less than the second speed threshold VfHith. Namely, the process of S1410 is the same process as the process of S925. In other words, the process of S1410 is a process to determine whether or not the fusion ground speed Vf(n) is within the first range.

When the fusion ground speed Vf(n) is within the first range, the CPU2 makes a “Yes” determination at S1410 to execute processes of S1115 and the following steps. When the fusion ground speed Vf(n) is not within the first range, the CPU2 makes a “No” determination at S1410 to directly proceed to S1495. At S1495, the CPU2 terminates the present routine tentatively.

According to the second modified embodiment, in a case where the fusion ground speed Vf(n) is within the first range (refer to S1410 in FIG. 14: Yes) at the time point at which the cumulative time of the third state in which the camera ground speed Vca(n) is within the second range in a case where the camera ground speed Vca(n) remains within the third range that includes the second range (i.e., the time corresponding to the value of the counter C(n)) becomes equal to or greater than the time threshold (i.e., the time corresponding to the counter threshold Cth) (refer to S1110 in FIG. 14: Yes), the obstacle anticipation assist control for the object n is performed. Accordingly, the second modified embodiment can also reduce the possibility that the obstacle anticipation assist control is erroneously performed due to the erroneous fusion. It should be noted that the execution order of S1110 and S1410 may be reversed.

### Third Modified Embodiment

Next, a third modified embodiment will be described. This third modified embodiment is different from the above-described second modified embodiment only in that it is configured to update the value of the counter C(n) without performing the process utilizing the third range. Hereinafter, this difference will be mainly described.

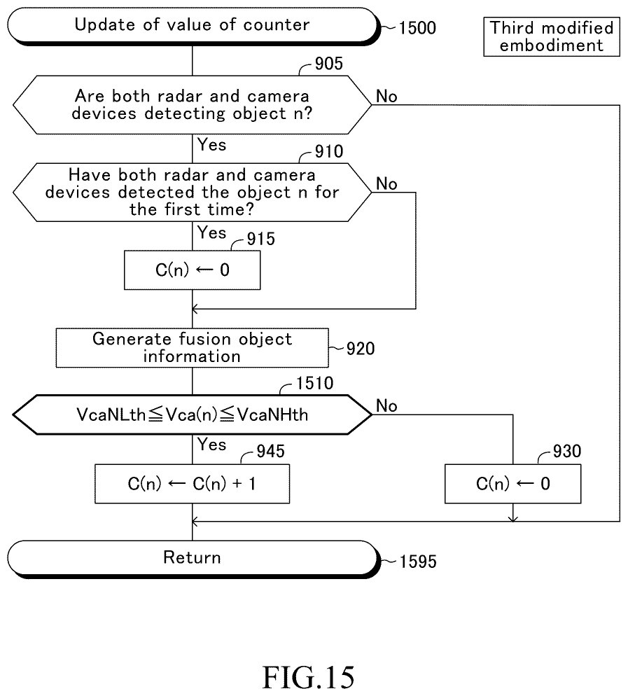

The CPU of the driving assistance ECU 10 of the third modified embodiment (hereinafter, referred to as a CPU3) is configured to execute a routine shown in a flowchart in FIG. 15 in place of FIG. 9 and a routine shown in a flowchart in FIG. 14 in place of FIG. 11. It should be noted that steps shown in FIG. 15 that perform the same processing as the steps shown in FIG. 9 are denoted by the same reference numerals as those shown in FIG. 9. Descriptions of such steps will be omitted as appropriate.

The routine shown in FIG. 15 is a routine obtained by omitting S925, S935, and S950 from the routine shown in FIG. 9 and adopting S1510 in place of S940 shown in FIG. 9. That is, when an appropriate time point comes, the CPU starts processing from S1500 in FIG. 15, and executes appropriate processes from S905 to S920 shown in FIG. 15. Thus, after the CPU3 generates the fusion object information at S920, the CPU3 proceeds to S1510 to perform the same process as the process at S940. That is, at S1510, the CPU3 determines whether or not the camera ground speed Vca(n) of the object n is within the second range.

When the camera ground speed Vca(n) is within the second range, the CPU3 makes a “Yes” determination at S1510 to proceed to S945. At S945, the CPU3 increments the value of the counter C(n) by 1. Thereafter, the CPU3 proceeds to S1595 to terminate the present routine tentatively.

In contrast, when the camera ground speed Vca(n) is not within the second range, the CPU3 makes a “No” determination at S1510 to proceed to S930. At S930, the CPU3 sets the value of the counter C(n) to 0. Thereafter, the CPU3 proceeds to S1595 to terminate the present routine tentatively.

According to the third modified embodiment, in a case where the fusion ground speed Vf(n) is within the first range (refer to S1410 in FIG. 14: Yes) at the time point at which the continuing time (i.e., the time corresponding to the value of the counter C(n)) of a fourth state in which the camera ground speed Vca(n) is within the second range becomes equal to or greater than the time threshold (i.e., the time corresponding to the counter threshold Cth) (refer to S1110 in FIG. 14: Yes), the obstacle anticipation assist control for the object n is performed as necessary. Accordingly, the third modified embodiment can also reduce the possibility that the obstacle anticipation assist control is erroneously performed due to the erroneous fusion. It should be noted that the counter threshold Cth is preferably 2 or more, but may be 1.

It should be noted that the present disclosure is not limited to the above-described embodiment and the modified embodiments, and may adopt various modified embodiments within the scope of the present disclosure. For example, the present disclosure can be applied to a vehicle that is in a state in which a driving mode has been transitioned from autonomous driving to driving by a driver in an autonomous vehicle.

Furthermore, the driving assistance apparatus according to the present disclosure may perform, in addition to the obstacle anticipation assist (OAA) control serving as the driving assistance control, collision avoidance control (AEB) to decelerate the host vehicle HV at a target deceleration whose magnitude is greater than the magnitude of the target deceleration (Dtgt) in the above-described obstacle anticipation assist control, when the time to collision TTC between the host vehicle and the object is equal to or less than an emergent/emergency time threshold TTEth which is smaller than any of the first time threshold TTC1th and the second time threshold TTC2th.

What is claimed is:

1. A driving assistance apparatus comprising:
a radar device configured to obtain radar object information on an object present ahead of a host vehicle using radar waves, said radar object information including a radar ground speed representing a ground speed of said object;
a camera device configured to obtain camera object information on an object present ahead of said host vehicle based on a captured image, said camera object information including a type of said object and a camera ground speed which represents a ground speed of said object;
a controller configured to generate fusion object information by fusing said radar object information and said camera object information and to perform driving assistance control to reduce a collision risk between an object present ahead of said host vehicle and said host vehicle,
wherein
said controller is configured to perform said driving assistance control in a case where a specific situation is occurring with respect to a specific object whose fusion object information has been generated, said specific situation is a situation in which said radar ground speed of said specific object serving as a fusion ground speed of said specific object included in said generated fusion object information is within a first range including 0 and said camera ground speed of said specific object is within a second range including 0.

2. The driving assistance apparatus according to claim 1, wherein
said controller is configured to determine that said specific situation is occurring when a total amount of time of a first state becomes equal to or greater than a predetermined time threshold, wherein said first state is a state in which said fusion ground speed of said specific object is within said first range and said camera ground speed of said specific object is within said second range while said camera ground speed of said specific object continues to be within a third range that includes said second range.

3. The driving assistance apparatus according to claim 1, wherein
said controller is configured to determine that said specific situation is occurring when a continuing time which is a duration for which a second state continues becomes equal to or greater than a predetermined time threshold, wherein said second state is a state in which said fusion ground speed of said specific object is within said first range and said camera ground speed of said specific object is within said second range.

4. The driving assistance apparatus according to claim 1, wherein
said controller is configured to determine that said specific situation is occurring when said fusion ground speed of said specific object is within said first range at a time point at which a cumulative time of a third state becomes equal to or greater than a predetermined time threshold, wherein said third state is a state in which said camera ground speed of said specific object is within said second range in a case where said camera ground speed of said specific object remains within a third range that includes said second range.

5. The driving assistance apparatus according to claim 1, wherein
said controller is configured to determine that said specific situation is occurring when said fusion ground speed of said specific object is within said first range, in a case where a continuing time which is a duration for which a fourth state continues becomes equal to or greater than a predetermined time threshold, wherein said fourth state is a state in which said camera ground speed of said specific object is within said second range.

6. The driving assistance apparatus according to claim 1, wherein
said controller is configured to:
use, as a longitudinal position of said specific object included in said fusion object information, a longitudinal position of said specific object included in said radar object information on said specific object;
use, as a lateral position of said specific object included in said fusion object information, a lateral position of said specific object included in said radar object information on said specific object;
use, as a relative speed of said specific object included in said fusion object information, a relative speed of said specific object included in said radar object information on said specific object; and
use, as a type of said specific object included in said fusion object information, a type of said specific object included in said camera object information on said specific object.

7. A driving assistance method comprising:
a step of obtaining radar object information on an object present ahead of a host vehicle from a radar device configured to use radar waves, said radar object information including a radar ground speed representing a ground speed of said object;
a step of obtaining camera object information on an object present ahead of said host vehicle based on an image captured by a camera device, said camera object information including a type of said object and a camera ground speed which represents a ground speed of said object included in said camera object information;
a step of generating fusion object information by fusing said radar object information and said camera object information; and
a step of performing driving assistance control to reduce a collision risk between an object present ahead of said host vehicle and said host vehicle, in a case where a specific situation is occurring with respect to a specific object whose fusion object information has been generated, said specific situation is a situation in which said radar ground speed of said specific object serving as a fusion ground speed of said specific object included in said generated fusion object information is within a first range including 0 and said camera ground speed of said specific object is within a second range including 0.

8. The driving assistance method according to claim 7, wherein
said step of performing driving assistance control includes a step of determining that said specific situation is occurring when a total amount of time of a first state becomes equal to or greater than a predetermined time threshold, wherein said first state is a state in which said fusion ground speed of said specific object is within said first range and said camera ground speed of said specific object is within said second range while said camera ground speed of said specific object continues to be within a third range that includes said second range.

9. The driving assistance method according to claim 7, wherein
said step of performing driving assistance control includes a step of determining that said specific situation is occurring when a continuing time which is a duration for which a second state continues becomes equal to or greater than a predetermined time threshold, wherein said second state is a state in which said fusion ground speed of said specific object is within said first range and said camera ground speed of said specific object is within said second range.

10. The driving assistance method according to claim 7, wherein
said step of performing driving assistance control includes a step of determining that said specific situation is occurring when said fusion ground speed of said specific object is within said first range at a time point at which a cumulative time of a third state becomes equal to or greater than a predetermined time threshold, wherein said third state is a state in which said camera ground speed of said specific object is within said second range in a case where said camera ground speed of said specific object remains within a third range that includes said second range.

11. The driving assistance method according to claim 7, wherein
said step of performing driving assistance control includes a step of determining that said specific situation is occurring when said fusion ground speed of said specific object is within said first range, in a case where a continuing time which is a duration for which a fourth state continues becomes equal to or greater than a predetermined time threshold, wherein said fourth state is a state in which said camera ground speed of said specific object is within said second range.

12. The driving assistance method according to claim 7, wherein
said step of generating said fusion object information including:
a step of adopting, as a longitudinal position of said specific object included in said fusion object information, a longitudinal position of said specific object included in said radar object information on said specific object;
a step of adopting, as a lateral position of said specific object included in said fusion object information, a lateral position of said specific object included in said radar object information on said specific object;
a step of adopting, as a relative speed of said specific object included in said fusion object information, a relative speed of said specific object included in said radar object information on said specific object; and
a step of adopting, as a type of said specific object included in said fusion object information, a type of said specific object included in said camera object information on said specific object.

13. A non-transitory storage medium storing a program, said program causing a computer to implement:
a step of obtaining radar object information on an object present ahead of a host vehicle from a radar device configured to use radar waves, said radar object information including a radar ground speed representing a ground speed of said object;
a step of obtaining camera object information on an object present ahead of said host vehicle based on an image captured by a camera device, said camera object information including a type of said object and a camera ground speed which represents a ground speed of said object included in said camera object information;
a step of generating fusion object information by fusing said radar object information and said camera object information; and
a step of performing driving assistance control to reduce a collision risk between an object present ahead of said host vehicle and said host vehicle, in a case where a specific situation is occurring with respect to a specific object whose fusion object information has been generated, said specific situation is a situation in which said radar ground speed of said specific object serving as a fusion ground speed of said specific object included in said generated fusion object information is within a first range including 0 and said camera ground speed of said specific object is within a second range including 0.
